(19) United States
(12) Patent Application Publication
(10) Pub. No.: US 2005/0125349 A1
(43) Pub. Date: Jun. 9, 2005

(54) Channel services method and system for an electronic real property conveyancing marketplace

(76) Inventor: Jean-Luc Bressard, London (GB)

Correspondence Address: DOCKET CLERK, DM/EDS, P.O. DRAWER 800889, DALLAS, TX, 75380, US

(21) Appl. No.: 10/727,417

(22) Filed: Dec. 4, 2003

(51) Int. Cl. G06F 17/60

(52) U.S. Cl. 705/42

(57) ABSTRACT

A communications channeling method and system (140) for channeling communications relating to the electronic conveyancing of property selectably presents on-line consumer layer property conveyancing software applications (238) using a messaging hub web browser (142) associated with a gateway (140). The web browser (142) allows tailored access to the plurality of on-line consumer layer property conveyancing software applications (238). The method and system adaptably channel on-line service provider layer property conveyancing software applications (242) from associated software service providers (164) to the gateway (140) according to selections relating to the intended use of the on-line consumer layer property conveyancing software applications (238). Communications channeling further involves interfacing the on-line service provider layer property conveyancing software applications (242) with a plurality of back-end management software applications (220) serving back-office service providers (171, 174). The back-office management software applications (220) augment back-office operations relating to the on-line service provider layer property conveyancing software applications (242).

### TECHNICAL FIELD OF INVENTION

The invention, in general, relates to a channel services method and system for an electronic real property conveyancing marketplace and, more particularly, to a method and system for electronically associating governmental representatives, professional services participants, financial advisors, lenders and purchasers of real property to form and maintain a significantly enhanced real property conveyancing marketplace.

### BACKGROUND OF THE INVENTION

The present invention relates to the creation of a channel services utility for the domestic property conveyancing market, such as that of the United Kingdom, Continental Europe, the U.S., and other governmental regions permitting the negotiated, free-market transfer of real property interests among individual, companies, and other legal entities. As used herein, the term “conveyancing” shall mean those actions by governmental bodies, financial institutions, solicitors and other attorneys, surveyors, purchasers, and others involved in performing business actions and taking legal measures for the efficient and legally recognizable transfer of real property and interests therein among different owners and rights holders.

In existing free-market real property conveyancing systems, modern lending institutions employ computer-based loan management systems which store and process information on loans to debtors. Known systems for managing loan amortization include a device for inputting data identifying a debtor, the amount of the loan to the debtor, the principal balance of the loan, the rate of interest payable on the principal balance of the loan and the term of the loan. In response to a time payment, a loan payment module receives the time payment signals and determines the appropriate allocation of the time payment between interest and principal in accordance with known amortization methods. A loan origination and administration module tracks the reduction in the principal by the time payment, and the reduced principal balance is stored in the memory. Conventional systems for managing the amortization of loans process signals indicative of each loan in accordance with fixed-rate loan processing methods or variable-rate loan processing methods.

In the art of mortgage loans and mortgage brokering, a relatively large amount of information, however, must be exchanged to conduct a loan transaction, such as a new home mortgage loan. In attempting to obtain a competitive loan for the borrower, or in attempting to maintain competitive rates for lenders to offer loans, this relatively large amount of information must be collected, compared, evaluated, and disseminated to possible counter-parties to the transaction. The parties in such a transaction may include a borrower and/or mortgage broker and the lender. Other parties can include appraisal agents, regulatory agencies, mortgage insurance companies, and secondary mortgage market participants.

In known practices, nearly all the information relating to a loan transaction is collected by hand, transmitted using paper applications, compared by human beings (whose responsibilities include loan evaluation, property appraisal, financial market evaluation, and setting of lending rates), and disseminated using paper “rate sheets” or similar advertising material. For example, a mortgage broker attempting to obtain a loan for a borrower might be required to interview that client, consult rate sheets from multiple lenders to determine appropriate lending programs which might be appropriate for that client, submit multiple applications (possibly on multiple different forms) to selected ones of those lenders, and await action on those applications before being able to advise that client. Similarly, a lender attempting to set lending rates might be required to examine the present interest rate market, determine the mix of qualified borrowers likely to apply, determine a set of lending programs and lending rates best suited to the market and the risk the lender is willing to bear, and periodically post rate sheets or similar advertising material to multiple mortgage brokers informing them of those lending programs and lending rates.

Upon receiving a loan application, the lender might also be required to independently evaluate the creditworthiness of the borrower and the value of the underlying property. As all of these operations are presently performed by hand, initiating loan transactions is relatively expensive.

Although some forms of automation are known, such as uniform credit scoring for loan applications and automatic generation of loan application documents, there are no known systems in the field of mortgage lending for providing relatively automatic and widespread dissemination of loan application information or lending program information for automated comparison in real time.

The fact that the majority of these operations are performed by hand, rather than with the aid of computer processing, also limits the flexibility of the parties to the transaction. For borrowers, it is relatively difficult to compare more than a relatively few lending programs. For lenders, it is relatively difficult to select anything but a relatively simple set of lending categories for prospective borrowers.

It is also practically impossible for lenders to experiment with new products without broadcasting knowledge of those new products to a wide population, including their competitors.

Banks underwrite loans and/or purchase loan portfolios of other banks or sell portions of their own loan portfolios. In doing so, banks customarily continually assess and reassess the quality of various loan portfolios, which quality depends on the interest rates earned on those loans, the customer payment history on the loans and other criteria. In any case, bank managers are responsible for managing loans totaling billions of dollars both as pure loan instruments and as products that require servicing.

In a larger sense, the UK property market has been heavily criticised for the way in which transactions are carried out. There is very little transparency in conveyancing services, vast sums of money can be spent for valuations and other surveys only for the purchasing consumer to lose the property at the last minute. In fact, the British government has been under pressure for many years to change this market. The urge to change such a situation is so acute, that it became a manifesto pledge of the current government to remedy the ills that afflict the property market. For example, in the UK, both the government and the industry have rejected plans to align the English and Welsh markets with the Scottish market, due to the complexity and costs associated with making such a change.

By looking at the governments plans for electronic conveyancing, it is not difficult to identify the benefits to government agencies. These may include a reduction in real estate tax avoidance, process improvement in operations creation of knowledge repository for property transactions, as well as other benefits. These benefits to those in the business of conveyancing real estate must be made clearer.

A need exists, therefore, for a method and system for facilitating the establishment of an electronic real estate conveyancing environment for conveyancing real estate.

A need also exists for a structure permitting electronic commerce in real estate documentation, authorizations, surveys, conveyancing data, and other data relevant to the efficient and electronic conveyancing of real property. In particular, there is a need for a channeling utility that effectively ties together all necessary participants to achieve an efficiently operating real property conveyancing marketplace.

A further need exists for a system facilitating the adoption of an efficient and user-friendly electronic real estate conveyancing marketplace. In fact, there is the need for the appropriate utilities in such a property conveyancing system that provide compelling economic motivation for all participants to enter and operate within the system for all property conveyancing tasks and responsibilities.

### SUMMARY OF THE INVENTION

The present invention provides a method and system for channeling communications and applications within an electronic real property conveyancing marketplace for the purpose of electronically associating governmental representatives, professional services participants, financial advisors, lenders and purchasers to eliminate or substantial reduce problems associated with existing real property conveyancing marketplaces and known attempts to form electronically enhanced marketplaces for the purpose of legally and profitably conveyancing real property.

According to one aspect of the invention, there is provided a communications channeling method and system for channeling communications relating to the electronic conveyancing of property selectably presents on-line consumer layer property conveyancing software applications using a messaging hub web browser associated with a gateway. The web browser allows tailored access to the plurality of on-line consumer layer property conveyancing software applications. The method and system adaptably channel on-line service provider layer property conveyancing software applications from associated software service providers to the gateway according to selections relating to the intended use of the on-line consumer layer property conveyancing software applications. Communications channeling further interfaces the on-line service provider layer property conveyancing software applications with a plurality of back-end management software applications serving back-office service providers. The back-office management software applications augment back-office operations relating to the on-line service provider layer property conveyancing software applications.

A technical advantage of the present invention includes the formation of digitally-connected communities within the real property conveyancing marketplace. Through these efficiently channelling communications across these communities, both the number and quality of real property transactions can improve, while the community successfully lowers the individual and aggregate costs for such transactions.

Another technical advantage of the present invention includes facilitating the establishment of a critical mass of participants in the electronic real property conveyancing marketplace. This critical mass has the ability to establish de facto and, where appropriate, de jure standards for the electronically enhanced transfer of real property interests.

One aspect of the present invention includes providing a commercially attractive, electronically-enhanced real property conveyancing marketplace. By facilitating the messaging associated with a leveraged and flexible suite of widely accepted information technology applications, the present invention makes possible a significantly improved real property conveyancing marketplace.

Another technical advantage of the present invention includes the ability to significantly improve the management of a real property conveyancing marketplace. Due to the necessary governance and control of the transactions within an economy for transfer of real property, by more completely and effectively supporting the communication channel amongst those participants involved in the real property conveyancing marketplace, the responsible governing body, such as a land registry office, can more effectively monitor and manage the many segments of the property conveyancing marketplace.

Another particularly important technical advantage of the present invention is the establishment of an effectively channeled electronic real property conveyancing communications to provide a foundation for further technical improvement and enhancement of activities, transactions, and real property conveyancing reports. Through enhanced messaging layers between the purchasers and their agents on the one hand and the various applications of solicitors, lending institutions, solicitors/attorneys, and governmental officer on the other hand, the present invention sets the stage for an ever improving electronic real property conveyancing marketplace.

Another technical advantage of the present invention is that by virtue of allowing the electronic conveyancing of real property and the more complete information than such a system makes available, the present invention makes it possible for banks to understand and know more completely their cash outlay requirements relating to real property transfers. As a result, the present invention improves the ability of a financial institution such as a lender to understand or to make the appropriate cash calls or resource allocations for property conveyances drastically increases. Thereby, the present invention can generate significant savings in an electronically enhanced property conveyance market. That is, the present invention reduces delay, imprecision, uncertainties relating to cash requirements in the conveyancing of real property.

Still another technical advantage of the present invention is that it provides to the customer more complete information concerning the transactions, the transaction cost and the actual conveyance of real property from a buyer to a seller.

Another technical advantage of the present invention is the fact that by virtue of improved messaging and communications, the entire real property conveyancing marketplace has more complete information at all points. Accordingly, a reduced likelihood of fraud in the conveyance of real property arises. This benefit may significantly reduce the overall infrastructure costs for servicing and maintaining a real property conveyancing marketplace.

Other technical advantages are readily apparent to one skilled in the art from the following FIGUREs, description, and claims.

### BRIEF DESCRIPTION OF THE DRAWINGS

For a more complete understanding of the present invention and advantages thereof, reference is now made to the following description which is to be taken in conjunction with the accompanying drawings and in which like reference numbers indicate like features and further wherein:

FIG. 1 illustrates a general purpose computing system that may be part of a network of such computing systems for employing the method and system for conveyancing property of the present invention;

FIG. 2 shows an electronically connected network illustrating an environment capable of accepting the method and system of the present invention for electronically assisted conveyancing of property;

FIG. 3 presents a conceptual illustration of a the present invention method for providing a messaging and applications hub within an electronic property conveyancing environment according to the teachings of present invention;

FIG. 4 depicts one view of how the present invention creates value in processes supporting the conveyancing of property in an electronic property conveyancing marketplace forming a community of digitally associated lenders, attorneys, and businesses;

FIG. 5 shows one configuration of a plurality of transaction channels through which the present invention enables the electronic conveyancing of property;

FIG. 6 illustrates a variety of transactional and support services and related functions provided by the electronic property conveyancing system of the present invention;

FIG. 7 provides a conceptual view of tracking, middleware messaging, and information sharing messaging for establishing the electronic property conveyancing environment of the present invention;

FIG. 8 shows the functional and structural interfaces for a lending organization participating in the electronic conveyancing method and system of the present invention;

FIG. 9 presents the functional and structural interfaces for an employing organization participating in the electronic conveyancing method and system of the present invention; and

FIG. 10 depicts the functional and structural interfaces for a surveying organization participating in the electronic conveyancing method and system of the present invention.

### DETAILED DESCRIPTION OF PREFERRED EMBODIMENT

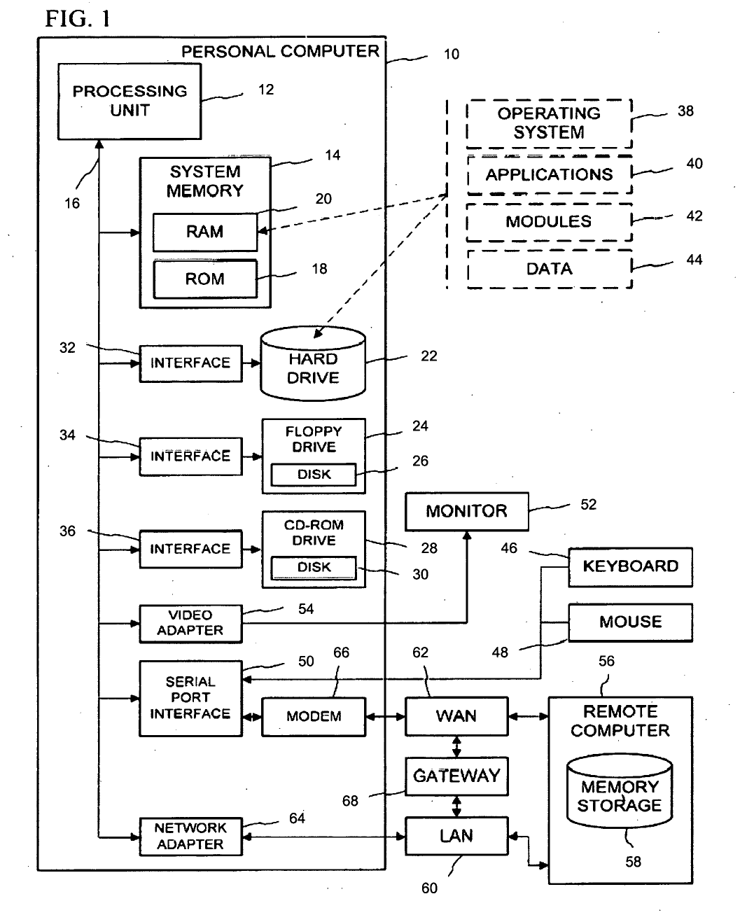

The preferred embodiment of the present invention and its advantages are best understood by referring to FIGS. 1 through 10 of the drawings, like numerals being used for like and corresponding parts of the various drawings.

FIG. 1 illustrates a general purpose computing system that may be part of a network of such computing systems for employing the method and system for conveyancing property of the present invention. By associating a network of general-purpose computers 10, the present invention is useable in establishing a fully automated and interactive environment, including all necessary security, privacy, verification, and operational tools for significantly increasing the conveyancing of property, such as real estate or other properties. In such an electronic conveyancing environment as established by the present invention, at least two such computers may be operated at different locations within a given geographical or similarly bounded area.

With reference to FIG. 1, general-purpose computer 10 may be a personal computer, a laptop, palmtop, or other set top, server, mainframe, and other variety computer, and include processing unit 12, system memory 14, and system bus 16 coupling various system components including system memory 14 to the processing unit 12. Processing unit 12 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 12.

System bus 16 may be any of several types of bus structures including a memory bus or memory controller, a peripheral bus, and a local bus using any of a variety of conventional bus architectures such as PCI, VESA, AGP, Microchannel, ISA and EISA, to name a few. System memory 14 includes read only memory (ROM) 18 and random access memory (RAM) 20. A basic input/output system (BIOS), containing the basic routines helping to transfer information between elements within the computer 10, such as during start-up, is stored in ROM 18.

Computer 10 further includes a hard disk drive 22, a floppy drive 24, e.g., to read from or write to a removable disk 26, and CD-ROM drive 28, e.g., for reading a CD-ROM disk 30 or to read from or write to other optical media. The hard disk drive 22, floppy drive 24, and CD-ROM drive 28 are connected to the system bus 16 by a hard disk drive interface 32, a floppy drive interface 34, and an optical drive interface 36, respectively. The drives and their associated computer-readable media provide nonvolatile storage of data, data structures, computer-executable instructions, etc., for computer 10. Although the description of computer-readable media provided above refers to a hard disk, a removable floppy and a CD, those skilled in the are may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 20, including an operating system 38, one or more application programs 40, other program modules 42, and program data 44. A user may enter commands and information into the computer 10 through a keyboard 46 and pointing device, such as mouse 48. Other input devices (not shown) may include a microphone, joystick, game pad, satellite dish, scanner, or the like. These and other input devices are often connected to the processing unit 12 through a serial port interface 50 coupling to the system bus, but possibly connecting by other interfaces, such as a parallel port, game port or a universal serial bus (USB). A monitor 52 or other type of display device is also connected to the system bus 16 via an interface, such as a video adapter 54. In addition to the monitor, computers typically include other peripheral output devices (not shown), such as speakers and printers.

Computer 10 may operate in a networked environment using logical connections to one or more remote computers, such as a remote computer 56. Remote computer 56 may be a server, a router, a peer device or other common network node, and typically includes many or all of the elements described relative to the computer 10, although only a memory storage device 58 has been illustrated in FIG. 1. The logical connections depicted in FIG. 1 include a local area network (LAN) 60 and a wide area network (WAN) 62. Such networking environments are commonplace in offices, enterprise-wide computer networks, intranets and the Internet.

When used in a LAN networking environment, the computer 10 is connected to the LAN 60 through a network interface or adapter 64. When used in a WAN networking environment, computer 10 typically includes a modem 66 or other means for establishing communications (e.g., via the LAN 60 and a gateway or proxy server) over the wide area network 62, such as the Internet. Modem 66, which may be internal or external, is connected to the system bus 16 via the serial port interface 50. In a networked environment, program modules depicted relative to the computer 10, or portions thereof, may be stored in the remote memory storage device 58.

Those skilled in the art may appreciate the network connections shown as exemplary, wherein other means of establishing a communications link between the computers may be used. FIG. 1 only provides one example of a computer useful for employing the teachings of the present invention. The invention may be used in computers other than general-purpose computers, as well as on general-purpose computers without conventional operating systems.

The present invention provides to different participants in real property conveyancing process a communications channeling and applications software interface for enabling the establishment of an electronic conveyancing marketplace. The tasks within the conveyancing marketplace are those associated with the mortgage value chain. The present invention streamlines these tasks, in part, by eliminating the need for the various participants to repeatedly state their name, their positions relative to the conveyancing of real property and their respective roles in assuring that the conveyancing takes place appropriately.

The channeling utility of the present invention, moreover, relates to the overall real property conveyancing marketplace, as opposed to focusing on simply an individual transaction. However, by virtue of the communications channel support services and functions that the present invention provides, individual transactions are significantly facilitated, validations and verifications occur more efficiently, and those participating in the conveyancing of real estate on either the government side, as it relates to deeds, and property ownership and transfer documents, or the service provider side, such as solicitors or attorneys, surveyors, lenders and borrowers, a significantly more efficacious platform results than has heretofore been available.

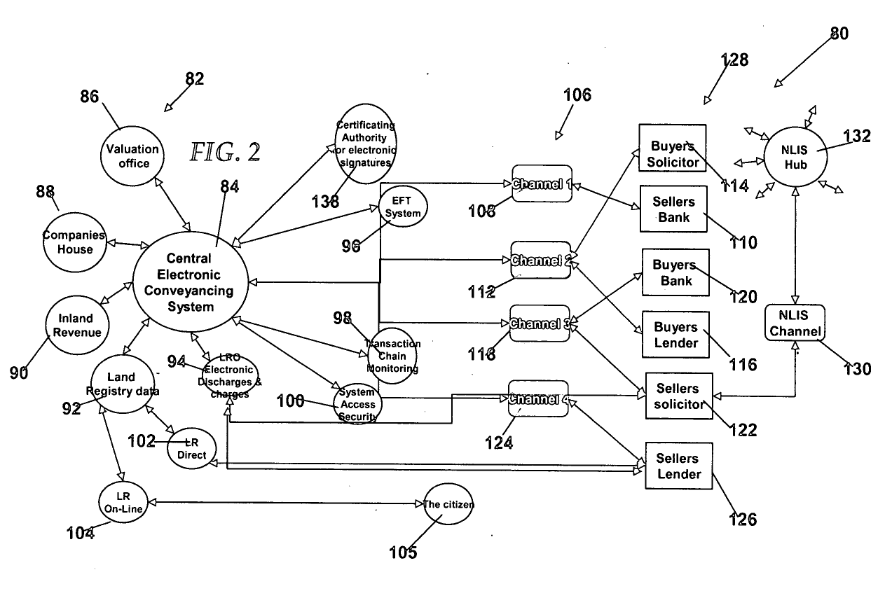

In a governmental system intending to put forth an electronic conveyancing marketplace, the present invention has significant application. This may be, for example, such as proposed of late by the land registry in the UK or in other governments where there is sufficient interconnectivity and sophistication in the computer systems that an electronic conveyancing environment may be established. Such an electronic conveyancing environment or marketplace is described in FIG. 2. In such an environment there may or may not be a secure governmental gateway into the marketplace. However, such is not necessary for the implementation of the present invention nor is it required that such an electronic conveyancing marketplace have such a gateway.

FIG. 2, therefore, shows an electronic real property conveyancing marketplace 80 capable of employing the communications channel utility of the present invention. Conveyancing system 80 of FIG. 2 may employ the teachings of the present invention and include a government zone 82 which includes central electronic conveyancing system 84 that associates with different applications and functions of government zone 82. This may include, for example, valuation office functions 86, companies house functions 88, and inland revenue operations functions 90. In addition, land registry data functions 92 interface central electronic conveyancing system 84. Land registry office electronic discharges & charges functions 94 also interface with central electronic conveyancing system 84. Other interfaces with central electronic conveyancing system 84 may be EFT system 96, transaction chain monitoring system 98 and system access security functions 100. Land registry direct functions 102 and land registry online functions 104 also interface with land registry data resources 92. Land registry on-line functions 104 also interface, for example, citizen functions 105. Between the government portions 82 of conveyancing system 80, a number of channels 106 interface and provide communication to government portion 82. These channels may include, for example, channel 1 108 which interfaces a seller's bank 110, channel 2 112 which interfaces a buyer's solicitor 114 and, perhaps, buyer's lender 116. Channel 3 118 may interface buyer's bank 120 as well as seller's solicitor 122. Moreover, channel 4 124 may interface seller's lender 126.

Different offices 128, which include the previously identified buyer's solicitor 114, seller's bank 110, buyer's bank 120, buyer's lender 116, seller's solicitor 122, and seller's lender 126, represent different offices or different functions that may interface with government portion 82 or conveyancing system 80. Note that a direct connection may exist between land registry direct functions 102 and seller's lender 126, as well as between land registry office discharges and charges functions 94 and seller's lender 126. Seller's solicitor 122 may interface through national land information service channel 130 to national land information service hub 132. Through land registry online function 104, the citizen 105 may interface with government portion 82 of property conveyancing system 80.

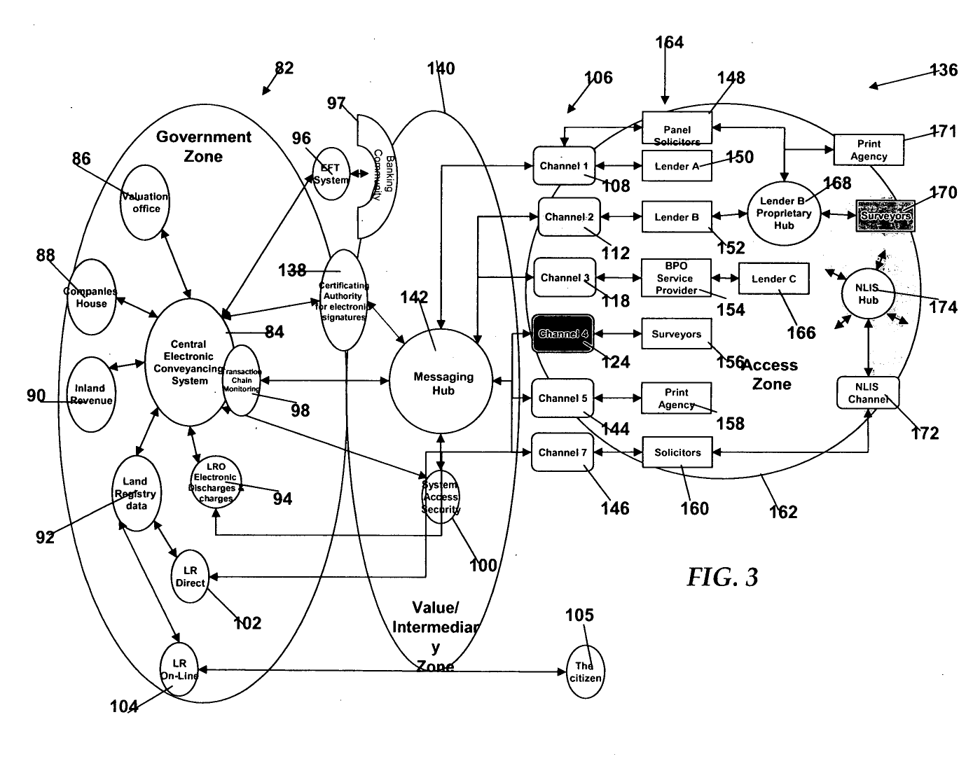

FIG. 3 presents a conceptual illustration of the communications channeling method and system of the present invention for conveyancing property. In FIG. 3, automated property conveyancing environment 136 includes, as was the case in FIG. 2, government zone 82 which includes previously described interfaces and components, as well as certifying authority for electronic signatures functions 138 which interfaces value/intermediary zone 140 provided by the present invention. A significant component of value/intermediary zone 140 is messaging hub 142. Messaging hub 142 provides an interface with certifying authority for electronic signatures 138, transaction chain monitoring faculty 98 and system access security module 100. In addition, messaging hub 142 interfaces channel 1 108, channel 2 112, channel 3 118, channel 4 124, channel 5 144, and channel 7 146.

In electronic conveyancing environment 136, in which the present invention operates, channels 106 are external to and not regulated by the governmental zone of the electronic conveyancing environment. The present invention provides the value/intermediary zone 140 by which the various participants within the private or access zone 162 interface through messaging hub 142 to government zone 82 and significantly increase and reduce cost associated with the conveyancing of real property.

Similar to the interfaces presented in FIG. 2, channels 106 provide interfaces to panel solicitors 148 via channel 1 106 as well as lender A 150. Channel 2 may interface lender B 152, while channel 3 118 may interface BPO service provider 154. Channel 4 124 may interface surveyors in the environment, while channel 5 142 interfaces print agency 158, and channel 7 146 interfaces solicitors 160. Within access zone 162 the different service providers 164, as previously described, may serve in an electronically augmented environment which may include a number of specific applications and services that, through channels 106, interface with value/intermediary zone 140. Moreover, individual associations, such as BPO service provider 154 associates with lender C 166, as well as lender B association with lender B proprietary hub 168, which also may interface print agency 171 and panel solicitors 148. Furthermore, a proprietary hub such as lender B proprietary hub 168 may interface with surveyors 170. Furthermore, solicitors 160 may interface national land information service or NLIS channel 172 to provide access to NLIS hub 174. In FIG. 3, NLIS hub 174 provides information including whether or not the property is in a flood basin, any legal information relating the ownership or transfer of the property, as well as any other legal or environmental concerns that would relate to the existing property.

There are certain aspects of stakeholder buy-in, such as acceptance by the land registry office that the present invention addresses. The present invention makes easier the work of the land registry office employees, while presenting to them the opportunity of using a number of value-added services within a registry office. Externally, when stakeholders all participate fully in an electronic conveyancing vision, the transactions chains may include a combination of electronic conveyancing and conventional practices. Conveyancing professionals and the banking community can appreciate the transparency provided by the present invention. Mortgage lenders can appreciate that they have full title to properties on which they have provided mortgages. Successful implementation, therefore, may obviate the need for sellers packs since the new system will it itself speed up the house buying process. Moreover, citizens or individual purchasers will be able to monitor their transactions and, thereby, impose full price transparency in support of choice and competition in the real property conveyancing market.

By efficiently channelling communications in an electronic conveyancing marketplace 136, the present invention supports the creation of a conveyancing digital community that functions effectively using messaging hub 142 outside the government offices. Messaging hub 142 also reduces the volume of transactions and data processing within the governmental zone 82. This de-risks the actions and responsibilities of a land registry office within government zone 82. Messaging hub 142 also alleviates issues of data integrity and data repair. This, in turn, reduces the level on maintenance that the land registry office must apply to the central electronic conveyancing system 84, in the event that they choose to maintain electronic conveyancing within. The higher the volume of transactional flows that passes through the central electronic conveyancing system 84, the greater the onus on data integrity and security. The inclusion of messaging hub 142 means that the land registry office only receives data that they and other interested government zone 82 participants require. Accordingly, for example, the land registry office databases will therefore hold only relevant historical data.

There may be different ways of implementing value/intermediary zone 140 to achieve the needed critical mass that drives a sustainable revenue model for vendors and application software suppliers. This applies to both the participants cooperating to establish value/intermediary zone 140 and messaging hub 142, as well as those participants in governmental office functions of government zone 82. When considering the role of channels 106, therefore, the various business model options vary. Messaging hub 142, thus, may sit outside of government zone 82 or, alternatively, multiple channels 106 may interface directly with governmental zone 82 to central electronic conveyancing system 84. However, when such a direct connection exists, the government zone 82 must appropriately address the associated increased security and data integrity risks and full back-end integration concerns. However, value/intermediary zone 140 of the present invention can advantageously couple components to those participant in access zone 162 who are prepared to share the risk and rewards of operating the within electronic property conveyancing marketplace 136.

Within electronic conveyancing marketplace 136, management of the electronic funds transfer system is a viable and attractive option to third party suppliers, who may operate in association with a consortium of banks, for example. Messaging hub 142 provides a viable and attractive option that allows for the creation of additional value-added services. This could make value/intermediary zone 140 self-financing for long-term operation and maintenance. Electronic conveyancing marketplace 136 also creates potential opportunities for increases in the scope of value-added activities within or associated with value/intermediary zone 140.

In electronic property conveyancing marketplace 136, the complexity of having multiple suppliers in access zone 162 all contracting with a land registry office increases the risk in government zone 82. However, value/intermediary zone 140 may mitigate this risk by providing a program management component. Messaging hub 142 may also alleviate a significant portion of the complexity of the land registry office's responsibility for channel licensing by itself bearing the responsibility for channel licensing into government zone 82. Messaging hub 142 may provide the platform for maintaining data content, data format consistency, data update frequencies and general data quality. In addition to this, messaging hub 142 may support the management of change requirements from all participants in electronic conveyancing marketplace 136. The land registry office within government zone 82 may audit and regulate messaging hub 142, as well as the transactions passing through value/intermediary zone 140 from the channels 106.

Based on the potential solutions forming electronic property conveyancing marketplace 136, an environment may arise wherein multiple vendors, with differing architectures and business processes, values and commercial interests join together to deliver a target operational architecture for messaging hub 142 and value/intermediary zone layer 140. With a clear understanding of business requirements that define all participating stakeholder groups, the present invention provides for both business requirements and technology inputs from a wide array of stakeholder groups. Such groups may include, for example, citizens' bureaus, mortgage customer advocacy groups, commercial mortgage lenders, bar associations and law societies, vendors and solution providers, independent financial advisors, governmental offices and departments, the banking community, and surveyors.

Messaging hub 142 of value/intermediary zone 140 may require end-to-end telephony and systems support. Where technical issues arise that can be attributed for example to a channels 106 service provider, channels 106 service provider may provide sufficient support to users, perhaps on an ISP basis. Where the technical issues cannot be pinpointed to channels 106 connectivity, such as in areas of data quality, integrity, non-receipt of data or transaction failures, electronic conveyancing marketplace 136 may require a central support function.

Messaging hub 142 reduces the security risk/number of accesses to the central electronic conveyancing system 84. Because, business continuity is a major consideration to all aspects of electronic conveyancing marketplace 136, this reduction in security risks has clear advantages. Also relating to continuity is the requirement to provide adequate capacity through messaging hub 142 for the electronic government gateway. For example, there may be radical volume fluctuations due to seasonality between the summer and winter months. There may also be rapid changes in citizen preferences, such as increases in the volume of transactions that may occur on the last Friday of the month. This, too, messaging hub 142 can accommodate.

By supporting electronic conveyancing marketplace 136, the present invention helps to address the ills of the current real property conveyancing system, without causing damage to either the industry or the economy. The present invention also may address more specific issues surrounding unfavourable practices such as gazzumping or conveyancing races that may occur within a real property conveyancing marketplace. Electronic conveyancing creates greater transparency in property transactions at a low or acceptable price to conveyancing professionals or the general public. Establishing an electronic conveyancing marketplace may occur with no cumulative price increases in the conveyancing marketplace. Electronic conveyancing, therefore, delivers tangible benefits and improvements to the industry and the citizen, without disrupting the property industry.

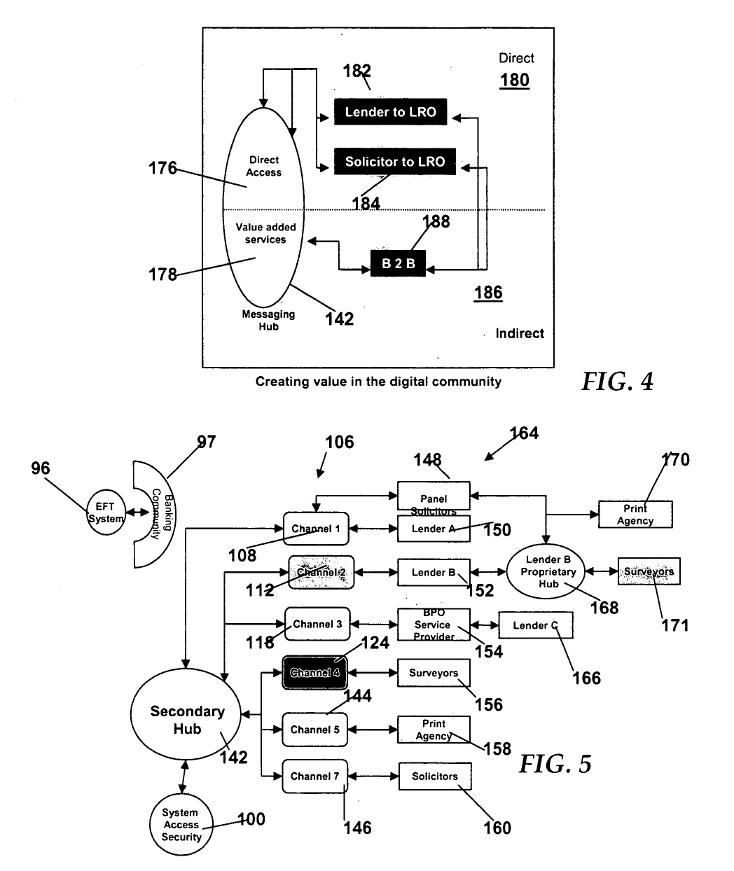

FIG. 4 depicts one view of how the present invention may create value in the processes supporting the conveyancing of property by interfacing with a digital community supporting in the processes and systems relating to property conveyancing. In particular, as referenced in FIG. 3, FIG. 4 shows that messaging hub 142 provides both direct access features 176 as well as value added services 178. For the direct portion of these services 180, direct access messaging hub permit interfaces 182 to the land registry office as well as interfaces 182 between a lender and the land registry office and 184 between a solicitor and a the land registry office. Moreover, indirect functions 186 provide, through business-to-business or B2B interfaces 188 the ability to interface with interfaces such as lender to the land registry office interface 182 and solicitor to the land registry office interface 184 and a variety of value added services 178 within messaging hub 142.

The present invention provides supply chain transparency between the different participants in the real property conveyancing market. The partitioning of messaging hub 142 allows lenders and solicitors, who may have a greater appetite for integration and more advanced technology maturity models, to submit the exact data requirements to central electronic conveyancing system 84. With the present invention, channels can be owned and operated by commercial entities, and enrolment mechanisms can be made unambiguous to all parties. Messaging hub 142 assumes responsibility for the authentication, validation and translation of data prior to transmitting such data to the central electronic conveyancing system 84. The central electronic conveyancing system 84 would, for the short-to-medium term be a static system, with all alterations (change requirements from channels or channel service providers) being made in messaging hub 142. Messaging hub 142 could also be considered as a transactional utility for ensuring that smaller solicitors offices in rural areas are not disenfranchised for not being technologically advanced. Conveyancing professionals involved in a chain may send electronic messages to each other via the messaging hub without significant investment in infrastructure. Messaging hub 142, therefore, significantly reduces conveyancing costs as well as transaction cycle times.

Business process outsourcing is common place in the conveyancing industry. With messaging hub 142, organizations transacting business on behalf of lenders may, for example, interface with messaging hub 142 on behalf of lenders. This ensures that all interested parties may provide input into a transactional history for a particular conveyance or set of conveyances. Still, however, lenders may themselves retain an interface to the electronic funds transfer system, as needed.

FIG. 4, therefore, addresses forming digital communities to support the electronic real property conveyance processes of the present invention. The present invention provides for the creation of a standard in the conveyancing of real property. As a result, within a governmental or geographical region the ability to establish an electronic conveyancing environment for conveyancing real property provides a platform for transacting business. Those not participating in the electronic conveyancing environment that the present invention facilitates will find themselves unable to perform the types of real property transactions that they desire to conduct while those participating in the electronic conveyancing environment will enjoy the benefits of the increased efficiencies, reduced transaction costs, and increased transaction volume that the electronic conveyancing environment makes possible.

FIG. 5 shows one configuration of a plurality of transaction channels 106 through which messaging hub 142 of the present invention enables the electronic conveyancing of property. Thus, within the contextual framework of FIG. 4, FIG. 5 shows the various channels 106 and interfaces, such as banking community gateway 97 with electronic funds transfer or EFT system 96, as well as messaging hub 142 and system access security functions 100. Through channels 106, the various service providers 164 may have an on-line interconnected electronic system for managing electronically and automatically, as appropriate, the process of conveyancing real property.

The present invention also supports the commercial sustainability of electronic property conveyancing environment 136 by supporting the creation of a critical mass of participants in the conveyancing transaction chain. This is, in part, due to the transparency in the conveyancing transaction that the present invention promotes. By supporting the timely submission of data to central electronic conveyancing system 84 within government zone 82, messaging hub 142 helps to reduce delay in the chain by facilitating document processing at the various the stages of the conveyancing transaction.

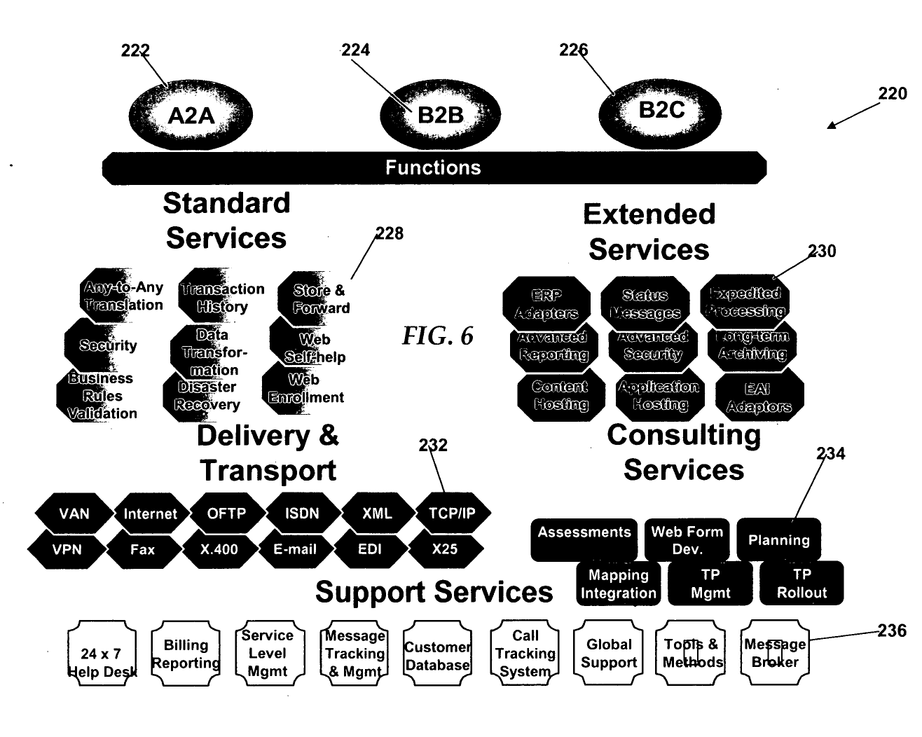

FIG. 6 illustrates conceptually some of the different functions and services 220 that may be useful in supporting messaging hub 142 within electronic property conveyancing marketplace 136. In particular, functions and services that value/intermediary zone 140 may employ include different ways of interfacing different entities as blocks 222, 224 and 226 may indicate. These functions are supported by a number of underlying services such as standard services 228 and extended services 230. Moreover, delivery and transport services 232 and consulting services 234 may support, respectively, standard services 228 and extend services 230. Such services may further be supported by support services 236.

Standard services 228 may include such services as any-to-any translation services, transaction history services, store & forward services. Moreover, security, data transformation and web self-help services may be provided as standard services. Finally, these services may further include business rules validation services, disaster recovery services and basic web enrollment services. Extended services may be more complex in nature and particular to different types of business processes. This may be, for example, ERP adaptors, status messages, expedited processing services, as well as advance reporting, advanced security, and long-term archiving services.

Content hosting, application hosting, and EAI adaptors, may also be part of extended services that would interface with and establish the electronic conveyancing services market of the present invention. As described above, delivery and transport services 232 may provide a variety of different hardware and software functions such as VAN, Internet, OFTP, ISDN, XML, and TCP/IP hardware and software services. In addition, VPN, Fax, X.400, eMail, EDI, and X25 services may be part of the delivery and transport services 232 that would support and be part of value/intermediary zone 140.

Furthermore, there are different consulting services 234 that may be appropriate for implementation with value/intermediary zone 140. This would include assessments, web form development, and planning, as well as mapping integration, TP management and TP rollout. Finally, support services that would be part of and integrated with the electronic property conveyancing system of the present invention would include services such as, 24×7 help desk, billing reporting, service level management, message tracking and management, customer databases, caller tracking systems, global support, tools and methods, as well as message brokering. Within a consolidated integrated environment such as the one described in FIG. 6, all of the functioning and reports of information and validation users can be provided and support the concept of a fully electronic property conveyancing environment 136.

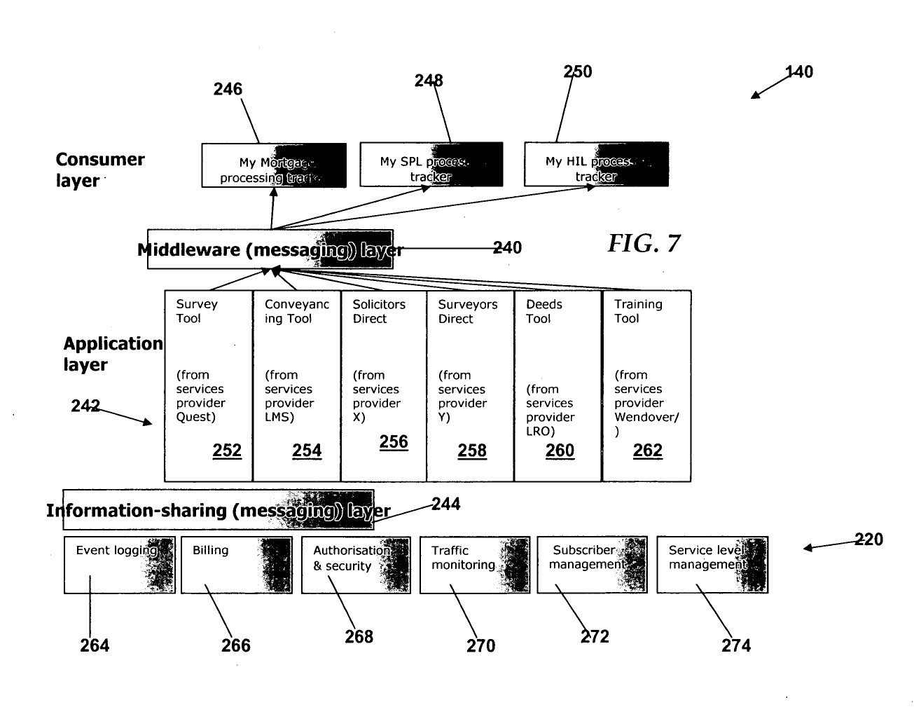

FIG. 7 more completely details value/intermediary zone 140 that the present invention provides for channeling communications within electronic property conveyancing marketplace 136. Within an associated web value/intermediary zone 140 appear consumer layer 238, middleware messaging layer 240 and application layer 242. Application layer 242 interfaces information-sharing or messaging layer 244 which itself interfaces the various services environment 220 as described in FIG. 6. Thus, consumer layer 238 may include a mortgage processing tracking facility 246, an SPL processing tracker 248 and an HIL processing tracker 250. These may interface individually or collectively with middleware messaging layer 240 to an application layer.

Within application layer 242 are variable tools and applications which may include survey tool 252, conveyancing tool 254, solicitors direct tool 256, surveyors direct tool 258, deeds tool 260, and training tool 262. Application layer may further interface with a number of information-sharing and other standard and extended services such as described in functions and services environment 220 of FIG. 6. These may include, specifically, event logging functions 264, billing functions 266, authorization and security functions 268, traffic monitoring function 270, subscriber management functions 272, and service level management function 274.

FIG. 7 shows that the present invention may provide a portal suite of products available on demand to lenders or other conveyancing professionals. The conceptual view of FIG. 7 shows that value/intermediary zone 140 provides tracking at consumer layer 238, middleware messaging at middleware layer 240, engaging applications at applications layer 242, and sharing information at information sharing layer 244. In a web-based system, a user can either access a lender or a database online. Thus, when a user interacts with the lender, the data may be captured by the user interface at consumer layer 238, which connects to respective lender at application layer 242. The user interface at consumer layer 238 may also access a state agency for the purpose of identifying a property that the user desires to purchase, also at application layer 242. The information relating the user's enquiry can then be reviewed and captured at information sharing layer 244. If the user obtains information as to whether there is or is not a mortgage relating to a particular piece of property, that fact can be made part of the electronic conveyancing dataset relating to that potential purchaser and/or the particular piece of property at functions and services environment 220.

Once the information that a buyer has an interest in a particular piece of property and the related mortgage information concerning the property is collected, this information may be transmitted to one or more lending organizations or agencies via information sharing layer 244. From that information, the agency may respond to the enquirer via middleware messaging layer 240 for the purpose of generating or making the potential buyer aware of one or more financial instruments that may be useful for establishing a new mortgage or replacing an existing mortgage at applications layer 242, in the event that the buyer or potential buyer decides to purchase the property.

At the appropriate point in the conveyancing transaction, the information relating to the potential financial instrument may be electronically conveyed to the solicitor or attorney that has the charge for creating the conveyancing documents such as title transfers and loan sales documents and the like for effecting the conveyancing transaction at applications layer 242. A principle benefit of this approach will be that the potential buyer will provide the information into the system only once at consumer layer 238, as opposed to the numerous times that the existing conveyancing system requires.

FIG. 7 shows that through consumer access layer 238 a consumer receives a window into the loan process for an individual loan requirement. The present invention, through middleware layer 240 facilitates the management of the various applications in application layer 242 for interfacing consumer layer 238. The present invention, through middleware layer 240, permits the consumer at consumer layer 238, to not only know where the individual transaction may be in the various application layers 242, but also to track its progress as the conveyancing transaction moves within conveyancing environment 136.

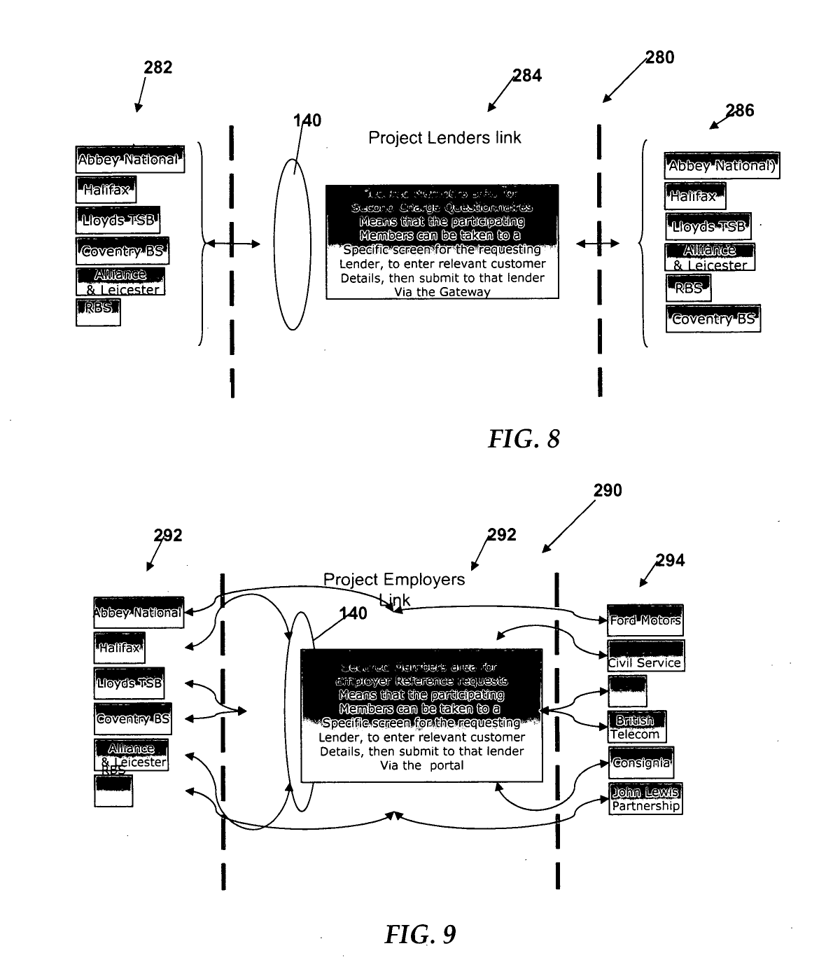

FIGS. 8, 9 and 10 depict the various links that the present invention establishes within the value/intermediary zone 140 for linking lenders, employers and surveyors within the automated electronic property conveyancing environment. Referring to FIG. 8, conceptual diagram 280 shows the various interfaces that value/intermediary zone 140 makes possible through the various channels 106 (see FIG. 3) for lenders 282, which may be such as lender A 150 or lender B 152 of FIG. 3 within access zone 162. Lenders 282 interface lenders link 284 for connecting with other lenders 286, in order that other lenders 286 can process applications for second charge questionnaires or previous lenders references. Currently these requests are sent on paper and chased manually by telephone. The present invention would reduce processing cycle time and back office costs of all lenders 282.

Value/intermediary zone 140 provides for secured members an area for secondary charge questionnaires to provide a means for participating lenders 282 to access a specific screen for requesting a lender to enter relevant details and such as described above and then submit that lender via a gateway which would be the gateway provided by value/intermediary zone 140. Then, in lenders ling 284 each submission from a lender's area may be accompanied by a unique electronic signature which would confirm the authenticity of the submission. This appears in region 284.

FIG. 9 presents in diagram 290 the functional and structural interfaces for an employing organization participating in the electronic conveyancing method and system of the present invention. Employers link 292 acknowledges that employers currently spend a vast amount of time processing references on behalf of their employees. The volume of reference requests received means that delays to the mortgage cycle are caused by backlogs and human resource professionals being on vacation. Depending on the level of integration chosen by the employer, the provider of electronic conveyancing marketplace 136 could provide either direct access to the portal thereby enabling employee validation direct into the lenders back office systems, or the request could be sent via the messaging hub 142. Messaging hub 142 would, then, integrate with the employers HR ERP systems to provide automatic validation of employee data.

In FIG. 9, therefore, conceptual diagram 290 similarly shows the construct by which employers may link with lenders 282 through value/intermediary zone 140 to constitute forming part of region 292 to various employers 294 for providing authentication of data relative to a particular individual or set of individuals.

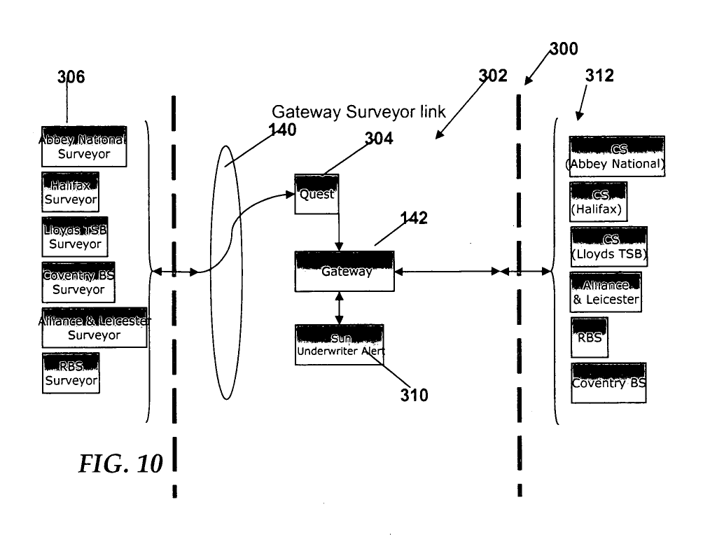

FIG. 10 depicts the functional and structural interfaces for a surveying organization which participates in the electronic conveyancing method and system of the present invention. Surveyor link 302 represents the act of processing surveys, which is the most expensive part of the mortgage process. For the aspect of the conveyancing marketplace, the present invention may provide an “underwriter alert” utility for effectively scanning the valuation/survey for key words in certain sections. These key words (e.g., subsidence, trees, etc.) would alert the system to the requirement of manual intervention. Where these words are not located, the valuation will be considered to be clean, the lenders back office system will be advised as such and an image copy of the survey will be sent to the lender. Lenders will be able to configure their module of Underwriter alert to whatever specification they require (as is required by their risk and securitization policies).

Conceptual diagram 300 of FIG. 10, therefore, shows surveyors link 302 that may exist when value/intermediary zone 140 interfaces with various surveyors such as surveyors 306, which may include, for example, surveyors operating on behalf of Abbey PLC, Halifax Bank of Scotland, and others. Through value/intermediary zone 140, surveyors' link 302 may channel a particular request or search for information as block 304 indicates within surveyors link 302 to interface with gateway or messaging hub 142 and DMPS underwriter alert 310. This interface would associate with various CS managed client back office systems such as region 312 indicates.

Accordingly, the embodiments of the invention herein described, it should to be understood, are merely illustrative of the application of the principles of the invention. For example, although the messaging hub 142 and value/intermediary zone 140 of present embodiment employ one or more versions of those systems made by EDS, such as that company's EBX or Electronic Business Exchange System, others may also employ one or more embodiment of the present invention. In addition, the approach used for the channeling utility of the present invention could be extended to other electronic commerce systems and tools. Reference herein to details of the illustrated embodiments, therefore, is not intended to limit the scope of the claims, which themselves recite those features regarded as essential to the invention.

1. A communications channeling method for channeling communications relating to the electronic conveyancing of property, comprising said steps of:
selectably presenting to a consumer a plurality of on-line consumer layer property conveyancing software applications using a messaging hub web browser associated with a gateway, said web browser allowing tailored access to said plurality of on-line consumer layer property conveyancing software applications;
adaptably channeling a plurality of on-line service provider layer property conveyancing software applications from associated software service providers to said gateway according to selections relating to said intended use of said on-line consumer layer property conveyancing software applications;
interfacing said plurality of on-line service provider layer property conveyancing software applications with a plurality of back-end management software applications serving back-office service providers, said back-office management software applications for augmenting back-office operations relating to said plurality of on-line service provider layer property conveyancing software applications.

2. The method of claim 1, wherein said plurality of on-line consumer layer property conveyancing software applications comprises an on-line loan processing software application for processing loan applications, and further comprising the step of linking a plurality of lenders amongst one another for electronically modifying later-generated loan documentation from a first lender with information associated with earlier-generated loan documentation.

3. The method of claim 1, further comprising the step of selectably controlling the degree of adaptation and interface complexity associated with said on-line service provider layer property conveyancing software applications for directing validated employee information into a plurality of back-office management software applications.

4. The method of claim 1, further comprising the step of interfacing said on-line service provider layer property conveyancing software applications with a plurality of back-end management software applications associated with a plurality of back-office service providers for alerting said back-office service providers to manually intervene with a property conveyancing transaction.

5. The method of claim 1, further comprising the step of interfacing said on-line service provider layer property conveyancing software applications with a plurality of back-end management software applications associated with a plurality of back-office service providers for alerting said back-office service providers to manually intervene with a property conveyancing transaction according to a predetermined set of risk and securitization policies.

6. The method of claim 1, further comprising the step of interfacing said on-line service provider property conveyancing software applications with a plurality of back-end management software applications associated with a plurality of back-office service providers for automatically verifying the correctness of a property valuation, and in response thereto transmitting an image copy of related property valuation documentation to a predetermined location.

7. The method of claim 6, further comprising the step of automatically transmitting said image copy of said related property valuation documentation to a predetermined property mortgage lender.

8. The method of claim 1, wherein said plurality of on-line service provider property conveyancing software applications comprises an on-line real estate data communications software application for recording and communicating real estate purchaser and property information, and further comprising the step of linking a plurality of real estate agents, a plurality of lenders, and a plurality of conveyancing solicitors amongst one another.

9. The method of claim 1, wherein said plurality of on-line service provider property conveyancing software applications comprises an on-line financial advisory data communications software application for recording and communicating financial advisory information, and further comprising the step of linking a plurality of financial advisors, a plurality of real estate agents, a plurality of lenders, and a plurality of conveyancing solicitor amongst one another.

10. The method of claim 1, further comprising the step of interfacing said on-line service provider property conveyancing software applications with a plurality of back-end management software applications associated with a plurality of back-office service providers for providing news and related information to users of said on-line consumer layer property conveyancing software applications.

11. A communications channeling system for channeling communications relating to the electronic conveyancing of property, comprising:
instructions for selectably presenting to a consumer a plurality of on-line consumer layer property conveyancing software applications using a messaging hub web browser associated with a gateway, said web browser allowing tailored access to said plurality of on-line consumer layer property conveyancing software applications;
instructions for adaptably channeling a plurality of on-line service provider layer property conveyancing software applications from associated software service providers to said gateway according to selections relating to said intended use of said on-line consumer layer property conveyancing software applications;
instructions for interfacing said plurality of on-line service provider layer property conveyancing software applications with a plurality of back-end management software applications serving back-office service providers, said back-office management software applications for augmenting back-office operations relating to said plurality of on-line service provider layer property conveyancing software applications.

12. The system of claim 11, wherein said plurality of on-line consumer layer property conveyancing software applications comprises an on-line loan processing software application for processing loan applications, and further comprising instructions for linking a plurality of lenders amongst one another for electronically modifying later-generated loan documentation from a first lender with information associated with earlier-generated loan documentation.

13. The system of claim 11, further comprising instructions for selectably controlling the degree of adaptation and interface complexity associated with said on-line service provider layer property conveyancing software applications for directing validated employee information into a plurality of back-office management software applications.

14. The system of claim 11, further comprising instructions for interfacing said on-line service provider property conveyancing software applications with a plurality of back-end management software applications associated with a plurality of back-office service providers for alerting said back-office service providers to manually intervene with a property conveyancing transaction.

15. The system of claim 11, further comprising instructions for interfacing said on-line service provider property conveyancing software applications with a plurality of back-end management software applications associated with a plurality of back-office service providers for alerting said back-office service providers to manually intervene with a property conveyancing transaction according to a set of risk and securitization policies.

16. The system of claim 11, further comprising instructions for interfacing said on-line service provider property conveyancing software applications with a plurality of back-end management software applications associated with a plurality of back-office service providers for automatically verifying the correctness of a property valuation, and in response thereto transmitting an image copy of related property valuation documentation to a predetermined location.

17. The system of claim 11, further comprising instructions for automatically transmitting said image copy of said related property valuation documentation to a predetermined property mortgage lender.

18. The system of claim 11, wherein said plurality of on-line consumer layer property conveyancing software applications comprises an on-line real estate data communications software application for recording and communicating real estate purchaser and property information, and further comprising instructions for linking a plurality of real estate agents, a plurality of lenders, and a plurality of conveyancing solicitors amongst one another.

19. A storage medium comprising a communications channeling system for channeling communications relating to the electronic conveyancing of property, said storage medium comprising:
instructions stored on said storage medium for selectably presenting to a consumer on-line consumer layer property conveyancing software applications using a messaging hub web browser associated with a gateway, said web browser allowing tailored access to said plurality of on-line consumer layer property conveyancing software applications;
instructions stored on said storage medium for adaptably channeling on-line service provider layer property conveyancing software applications from associated software service providers to said gateway according to selections relating to said intended use of said on-line consumer layer property conveyancing software applications;
instructions stored on said storage medium for interfacing said on-line service provider layer property conveyancing software applications with a plurality of back-end management software applications serving back-office service providers, said back-office management software applications for augmenting back-office operations relating to said on-line service provider layer property conveyancing software applications.

20. The storage medium of claim 18, wherein said plurality of on-line consumer layer property conveyancing software applications comprises an on-line loan processing software application for processing loan applications, and further comprising instructions for linking a plurality of lenders amongst one another for electronically modifying later-generated loan documentation from a first lender with information associated with earlier-generated loan documentation.
